(19) United States
(12) Patent Application Publication
(10) Pub. No.: US 2005/0260410 A1
(43) Pub. Date: Nov. 24, 2005

(54) Ceramic material powder, method of production thereof, dielectric ceramic composition, electronic device, and multilayer ceramic capacitor

(75) Inventors: Yoshinori Fujikawa, Chuo-ku (JP); Yuji Umeda, Chuo-ku (JP); Fumikazu Yamane, Chuo-ku (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/133,206

(22) Filed: May 20, 2005

(30) Foreign Application Priority Data
May 21, 2004 (JP) 2004-152052

(51) Int. Cl. C04B 35/468; B32B 5/16

(52) U.S. Cl. 428/403; 501/137

(57) ABSTRACT

A ceramic material powder comprised of main ingredient particles formed by barium titanate having on their surfaces a covering layer comprised of a secondary ingredient additive, wherein when an average radius of the main ingredient particles is “r” and an average radius of the covering layer is “Δr”, the Δr is controlled to a range of 0015r to 0.055r, thereby enabling acquisition of a multilayer ceramic capacitor or other electronic device satisfying both the X7R characteristic prescribed in the EIAJ standard and B characteristic prescribed in the Japan Industrial Standard (JIS), that is, excellent in temperature stability of the electrostatic capacity, having a good insulation resistance value, relative dielectric constant, or other characteristics, and having a long accelerated life of the insulation resistance.

### BACKGROUND OF THE INVENTION

1. Field of the Invention

The present invention relates to a ceramic material powder comprised of particles of barium titanate or another main ingredient material powder (hereinafter also referred to simply as “main ingredient particles”) having on their surfaces a covering layer comprised of a secondary ingredient additive and a method of production of the same, a dielectric ceramic composition produced using that ceramic material powder and used as a dielectric layer of for example a multilayer ceramic capacitor, a multilayer ceramic capacitor using that dielectric ceramic composition as a dielectric layer, or another electronic device.

2. Description of the Related Art

Multilayer ceramic capacitors are being broadly used as small sized, large capacity, high reliability electronic devices. The number used in each piece of electronic equipment is also rising. In recent years, along with the increasingly smaller size and higher performance of equipment, there have been increasingly stronger demands for multilayer ceramic capacitors to be made further smaller in size, larger in capacity, lower in cost, and higher in reliability.

Multilayer ceramic capacitors are normally produced by stacking internal electrode layer paste and dielectric layer paste by the sheet method, printing method, etc. and simultaneously firing them. For the conductive material of the internal electrode layers, relatively inexpensive Ni or Ni alloys or other base metals are used. When using a base metal as the conductive material of the internal electrode layers, if firing in the atmosphere, the internal electrode layers end up being oxidized, so the simultaneous firing of the dielectric layers and internal electrode layers has to be performed in a reducing atmosphere. However, if firing in a reducing atmosphere, the dielectric layers end up being reduced and the specific resistance ends up becoming lower, so nonreducible dielectric materials have been proposed.

As nonreducible dielectric materials, at the present time, ones satisfying the X7R characteristic prescribed in the EIAJ (Electronic Industries Association of Japan) standard (rate of change of electrostatic capacity of within ±15% based on 25° C. in temperature range of −55° C. to 125° C.) or B characteristic prescribed in the Japan Industrial Standard (JIS) (rate of change of electrostatic capacity of within 10% based on 20° C. in temperature range of −25 to 85° C.), that is, good in temperature stability of electrostatic capacity, are the mainstream.

However, multilayer ceramic capacitors using a nonreducible dielectric material have the problems of a shorter life of insulation resistance (IR) and a low reliability.

With layers being made rapidly thinner, unevenness of diffusion or segregation of the secondary ingredient additive in the dielectric layers becomes a cause of serious defects in the characteristics, quality, reliability, etc. of ceramic electronic devices. Therefore, to maintain the characteristics, quality, and reliability of this type of ceramic electronic device, uniform diffusion of the second ingredient additive in the dielectric layers is essential. Therefore, forming the targeted structure of the material powder at the stage of the material powder is essential,

In the past, as methods for suppressing segregation of the secondary ingredient additive, the method of using a fine secondary ingredient additive or method of preheating a plurality of secondary ingredient additives to form compounds, then finely pulverizing it for addition have been proposed. If using a dielectric material produced by these methods, it is possible to suppress segregation to a certain extent.

However, if the particle size of the secondary ingredient additive is made smaller, agglomeration easily occurs, so these were not fundamental methods of solution.

For realizing uniform quality, it is important to reliably distribute the secondary ingredient element in the individual ceramic main ingredient particles. As means for this, production of a ceramic material powder comprised of ceramic main ingredient particles uniformly covered by the secondary ingredient additive and production of high performance ceramic electronic devices by sintering the covered ceramic material powder have been sought.

Several proposals have been made on methods for uniformly covering the ceramic main ingredient particles with a secondary ingredient additive.

For example, Japanese Patent Publication (A) No. 63-141204 proposes a method of diffusing a metal oxide powder in a solution of a metal salt containing a metal element different from the ingredient of the metal oxide powder to deposit the metal element ingredient on the surface of the metal oxide.

Japanese Patent No. 3397156 proposes a method of diffusing a dielectric ceramic basic composition powder in water to obtain a slurry, adding an Si compound to the slurry to cause the Si compound to precipitate on the dielectric ceramic basic composition powder, then adding to the slurry containing the dielectric ceramic basic composition powder on which the Si compound was deposited, while stirring the slurry, a precipitating agent reacting with a solution containing the metal element forming the compound so as to form a precipitate to cause the desired metal element to deposit as a secondary ingredient element on the surface of the dielectric ceramic basic composition powder.

Japanese Patent Publication (A) No. 10-139553 proposes a method of mixing and pulverizing a ceramic basic composition powder together with an organic solvent and surfactant to make a slurry, then adding to and mixing with this slurry a complex alkoxide solution containing a metal element, then removing the organic solvent from the slurry to cover the powder by the complex alkoxide containing this metal element.

In recent years, multilayer ceramic capacitors are being required to be made thinner and greater in number of layers. Along with this, their dielectric layers are also being required to be more superior in relative dielectric constant, insulation resistance, load life characteristic, and other characteristics. As a factor having an effect on the characteristics of the dielectric layers, the microstructure of the ceramic forming the dielectric layers may be mentioned. This microstructure is believed to change by the state of the material powder and the reaction mechanism between material powders at the time of wintering.

However, in the past, it had been difficult to say that the reaction mechanism of the material powder was sufficiently considered. As explained above, attempts have been made to improve the homogeneity of the covering state of the material powder (see Japanese Patent Publication (A) No. 63-141204, Japanese Patent No. 3397156, and Japanese Patent Publication (A) No. 10-139553), but for example the average thickness of the covering layer formed by the secondary ingredient additive, the characteristics of the finally obtained capacitor, etc. cannot be said to have been sufficiently elucidated. Elucidation of these has been sought.

### SUMMARY OF THE INVENTION

An object of the present invention is to provide a ceramic material powder enabling acquisition of a multilayer ceramic capacitor or other electronic device satisfying both the X7R characteristic prescribed in the EIAJ standard and B characteristic prescribed in the Japan Industrial Standard (JIS), that is, excellent in temperature stability of the electrostatic capacity, having a good insulation resistance value, relative dielectric constant, or other characteristics, and having a long accelerated life of the insulation resistance and a method of production of the same, a dielectric ceramic composition produced using the ceramic material powder and used as for example a dielectric layer of a multilayer-ceramic capacitor, and a multilayer ceramic capacitor or other electronic device using the dielectric ceramic composition as a dielectric layer.

To achieve the object, according to the present invention, there is provided a ceramic material powder comprised of main ingredient particles made of barium titanate having on their surface a covering layer made of a secondary ingredient additive, wherein when an average radius of the main ingredient particles is “r” and an average thickness of the covering layer is “Δr”, the Δr is controlled to a range of r(α−β) to r(α+β).

According to the present invention, there is provided a method of producing a ceramic material powder comprised of main ingredient particles made of barium titanate having on their surface a covering layer made of a secondary ingredient additive, comprising a step of preparing a mixed solution of powder-state main ingredient particles and a solution-state secondary ingredient additive and a step of heat treating the mixed solution, a treatment temperature and treatment time of the heat treatment being changed to control an average thickness “Δr” of the covering layer to a range of r(α−β) to r(α+β) with respect to an average radius “r” of the main ingredient particles.

Here, the values of α and β are constants determined by the composition of the main ingredient particles, the type of the secondary ingredient additive forming the covering layer, etc.

The main ingredient particles are not particularly limited, but an oxide having a perovskite crystal structure etc. may be mentioned. The oxide having the perovskite (ABO₃) crystal structure is not particularly limited, but simple perovskite and also lithated perovskite, complex perovskite, etc. may be mentioned. The simple perovskite is not particularly limited, but BaTiO₃, CaTiO₃, SrTiO₃, CaZrO₃, SrZrO₃, etc. may be mentioned. Among these, as main ingredient particles, BaTiO₃ and other barium titanates are particularly preferably used.

When the main ingredient particles are comprised of barium titanate, the fact that the α is 0.035 and the β is 0.020 is confirmed by experiments of the present inventors.

That is, according to the present invention, there is provided a ceramic material powder comprised of main ingredient particles made of barium titanate having on their surface a covering layer made of a secondary ingredient additive, wherein when an average radius of the main ingredient particles is “r” and an average thickness of the covering layer is “Δr”, the Δr is controlled to a range of 0.015r to 0.055r.

According to the present invention, there is provided a method of producing a ceramic material powder comprised of main ingredient particles made of barium titanate having on their surface a covering layer made of a secondary ingredient additive, comprising a step of preparing a mixed solution of powder-state main ingredient particles and a solution-state secondary ingredient additive and a step of heat treating the mixed solution, a treatment temperature and treatment time of the heat treatment being changed to control an average thickness “Δr” of the covering layer to a range of 0.015r to 0.055r with respect to an average radius “r” of the main ingredient particles.

When the main ingredient particles are comprised of barium titanate, the secondary ingredient additive forming the covering layer preferably contains at least one type of magnesium oxide and/or a compound forming magnesium oxide after firing, manganese oxide and/or a compound forming manganese oxide after firing, and chromium oxide and/or a compound forming chromium oxide after firing.

Alternatively, as the secondary ingredient additive, at least one of vanadium oxide and/or a compound forming vanadium oxide after firing, tungsten oxide and/or a compound forming tungsten oxide after firing, tantalum oxide and/or a compound forming tantalum oxide after firing, and niobium oxide and/or a compound forming niobium oxide after firing is preferably contained.

Alternatively, as the secondary ingredient material, an R oxide (where R is at least one type of Sc, Er, Tm, Yb, Lu, Y, Dy, Ho, Tb, Gd, and Eu) and/or a compound forming an R oxide after firing is preferably contained.

Alternatively, as the secondary ingredient material, silicon oxide and/or a compound forming silicon oxide after firing is preferably contained.

Alternatively, as the secondary ingredient material, barium oxide and/or a compound forming barium oxide after firing, strontium oxide and/or a compound forming strontium oxide after firing, and calcium oxide and/or a compound forming calcium oxide after firing are preferably contained.

The ceramic material powder of the present invention can be suitably used as a material for a capacitor, PTC device, or other electronic device.

According to the present invention, there is provided a dielectric ceramic composition produced using any one of the above ceramic material powders having a main phase mainly comprised of a main ingredient and a segregated phase differing from the main phase in composition and crystal structure and including a secondary ingredient in an amount, converted to an oxide, of 10 wt % or more, an area ratio of the segregated phase at the time of observation of the cross-section of the dielectric ceramic composition being 8% or less of the area of the observation field.

The electronic device according to the present invention is not particularly limited so long as it is an electronic device having a dielectric layer. For example, it is a multilayer ceramic capacitor having a plurality of dielectric layers and internal electrode layers alternately stacked. In the present invention, the dielectric layers are comprised of the dielectric ceramic composition. The conductive material included in the internal electrode layers is not particularly limited, but for example is Ni or an Ni alloy.

The electronic device is not particularly limited, but a multilayer ceramic capacitor, a piezoelectric device, a chip inductor, a chip varistor, a chip thermistor, a chip resistor, or other surface mounted device (SMD) chip type electronic device may be mentioned.

Summarizing the effects of the invention, according to the present invention, there is provided a ceramic material powder comprised of barium titanate or other main ingredient particles having on their surfaces a covering layer comprised of a secondary ingredient additive, wherein the average thickness “Δr” of the covering layer is controlled to satisfy a predetermined relationship with respect to the average radius “r” of the main ingredient particles. Therefore, it is possible to provide a ceramic material powder enabling acquisition of a multilayer ceramic capacitor or other electronic device satisfying both the X7R characteristic prescribed in the EIAJ standard and B characteristic prescribed in the Japan Industrial Standard (JIS), that is, having a good temperature characteristic of the electrostatic capacity, and having a good insulation resistance value, relative dielectric constant, and other characteristics, and having a long accelerated life of the insulation resistance, a dielectric ceramic composition produced using the ceramic material powder and used for example for the dielectric layer of the multilayer ceramic capacitor, and a multilayer ceramic capacitor or other electronic device using the dielectric ceramic composition as a dielectric layer.

According to the method of production of a ceramic material powder of the present invention, when heat treating the mixed solution of the powder-state main ingredient particles and solution-state secondary ingredient additive, the heat treatment temperature and heat treatment time are changed. The average thickness “Δr” of the covering layer is controlled by this to satisfy a predetermined relationship with the average radius “r” of the main ingredient particles. As a result, it becomes possible to produce a ceramic material powder enabling acquisition of a multilayer ceramic capacitor or other electronic device satisfying both the X7R characteristic prescribed in the EIAJ standard and B characteristic prescribed in the Japan Industrial Standard (JIS), that is, having a good temperature characteristic of the electrostatic capacity, and having a good insulation resistance value, relative dielectric constant, and other characteristics, and having a long accelerated life of the insulation resistance.

### BRIEF DESCRIPTION OF THE DRAWINGS

These and other objects and features of the present invention will become clearer from the following description of the preferred embodiments given with reference to the attached drawings, wherein:

FIG. 1 is a schematic cross-sectional view of a multilayer ceramic capacitor according to an embodiment of the present invention,

FIG. 2 is a cross-sectional view schematically showing a ceramic material powder used for producing the multilayer ceramic capacitor of FIG. 1,

FIG. 3 is a photograph of a bright field image of a ceramic material powder of Sample 2 corresponding to an example of the present invention using a scanning transmission electron microscope (STEM),

FIG. 4 is a graph plotting the count of characteristic X-rays (K-lines) of Y detected when running an electron beam from the outside to inside of BaTiO₃ particles for ceramic material powder of Sample 2 corresponding to examples of the present invention,

FIG. 5 is a photograph showing an element mapping image of a ceramic material powder of Sample 2 corresponding to an example of the present invention using characteristic X-rays (K-lines) of Y,

FIG. 6 is a photograph of the bright field image of a sintered article of Sample 6 corresponding to Example 2 using STEM,

FIG. 7 is a photograph of the element mapping image of a sintered body of Sample 6 corresponding to Example 2 using the characteristic X-rays (K-lines) of Ba,

FIG. 8 is a photograph of the element mapping image of a sintered body of Sample 6 corresponding to Example 2 using the characteristic X-rays (K-lines) of Ti,

FIG. 9 is a photograph of the element mapping image of a sintered body of Sample 6 corresponding to Example 2 using the characteristic X-rays (K-lines) of Si, and

FIG. 10 is a photograph of the element mapping image of a sintered body of Sample 6 corresponding to Example 2 using the characteristic X-rays (K-lines) of Y.

### DESCRIPTION OF THE PREFERRED EMBODIMENTS

Below, the present invention will be explained based on the embodiments shown in the drawings.

Multilayer Ceramic Capacitor

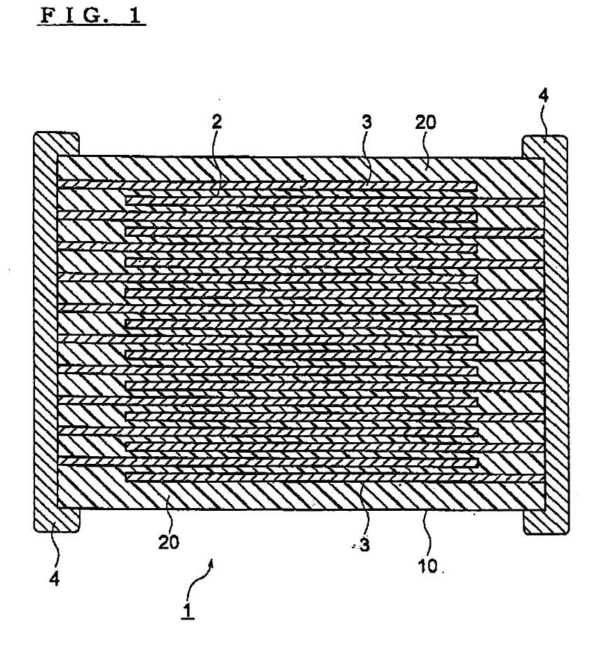

As shown in FIG. 1, a multilayer ceramic capacitor 1, one example of an electronic device of the present invention, has a capacitor body 10 comprised of interlayer dielectric layers 2 and internal electrode layers 3 alternately stacked. The capacitor body 10 is formed at its two ends with a pair of external electrodes 4 connecting to the internal electrode layers 3 alternately arranged in the body 10. The internal electrode layers 3 are stacked so as to be alternately exposed at the surfaces of the two facing ends of the capacitor body 10.

The pair of external electrodes 4 are formed at the two ends of the capacitor body 10 and are connected to the exposed end faces of the alternately arranged internal electrode layers 3 to form a capacitor circuit.

The outside shape or dimensions of the capacitor body 10 are not particularly limited and may be suitably set in accordance with the application, but the outside shape may normally be made substantially a parallelopiped and the dimensions may normally be a length of 0.4 to 5.6 mm×width of 0.2 to 5.0 mm×height of 0.2 to 1.9 mm or so.

The capacitor body 10 is provided at the two outside ends in the stacking direction of the internal electrode layers 3 and interlayer dielectric layers 2 with outside dielectric layers 20 which protect the inside of the body 10.

The interlayer dielectric layers 2 and outside dielectric layers 20 are not particularly limited in composition in the present invention, but for example are comprised of the following dielectric ceramic composition.

The dielectric ceramic composition of the present embodiment is a dielectric ceramic composition having for example barium titanate as its main ingredient. As the secondary ingredient contained together with the main ingredient in the dielectric ceramic composition, inclusion of at least one type of an oxide of Mn, Cr, Ca, Ba, Mg, V, W, Ta, Nb, or R (where R is at least one type of rare earth element such as Y) and a compound forming such an oxide after firing may be mentioned. By adding the secondary ingredient, it is possible to obtain characteristics as a capacitor even in a reducing atmosphere. Note that, as impurities, C, F, Li, Na, K, P, S, Cl, and other trace elements may be contained in amounts of 0.1 wt % or less. However, in the present invention, the interlayer dielectric layers 2 and outside dielectric layers 20 are not limited in composition to the above.

In the present embodiment, as the interlayer dielectric layers 2 and outside dielectric layer 20, the following compositions are preferably used.

This composition contains, as a main ingredient, barium titanate and, as a secondary ingredient, at least one of magnesium oxide, manganese oxide, and chromium oxide.

Further, as the secondary ingredient, at least one of vanadium oxide, tungsten oxide, tantalum oxide, and niobium oxide is preferably contained.

Alternatively, as the secondary ingredient, an R oxide (where R is at least one of Sc, Er, Tm, Yb, Lu, Y, Dy, Ho, Tb, Gd, and Eu) is preferably contained.

Alternatively, as the secondary ingredient, silicon oxide is preferably contained.

Alternatively, as the secondary ingredient, barium oxide, strontium oxide, and calcium oxide are preferably contained.

The number, thickness, and other conditions of the interlayer dielectric layers 2 may be suitably determined in accordance with the object and application, but in the present embodiment, the thickness of the interlayer dielectric layer 2 is made a thin 5 μm or less, preferably 3 μm or less, more preferably 1 μm or less. Further, the interlayer dielectric layers 2 are made of grains and grain boundary phases. The average particle size of the grains of the interlayer dielectric layers 2 is preferably 0.1 to 5 μm or so. This grain boundary phase is normally comprised of an oxide of the material forming the dielectric material or internal electrode material, an oxide of a separately added material, or an oxide of a material entering as an impurity during the process and normally is glass or glass-like.

In particular, the interlayer dielectric layers 2 are comprised of a main phase comprised of the main ingredient and a segregated phase differing in composition and crystal structure and containing the secondary ingredient in an amount, converted to oxide, of 10 wt % or more. Here, the “segregated phase” means a region where the secondary ingredient comprised of the different types of the secondary ingredient additives segregate and where the secondary ingredient is present in a relatively high concentration compared with the main phase mainly comprised of the main ingredient. Note that the reason for defining the segregated phase as the region including the secondary ingredient in an amount, converted to oxide, of “10 wt % or more” is that if less than 10 wt %, the secondary ingredient is dissolved in the main phase and the result corresponds to a shell.

Further, the area ratio of the segregated phase at the time of observation of the cross-section of the interlayer dielectric layer 2 is 8% or less of the area of the observation field, preferably 6% or less, more preferably 4% or less. If the area ratio of the segregated phase is over 8% of the area of the observation field, a relatively sufficient value of the relative dielectric constant is obtained, but the insulation resistance (IR) accelerated life tends to become extremely short and the temperature characteristic also tends to deteriorate.

Note that the composition of the segregated phase can for example be found by using an EDS system attached to a scanning transmission electron microscope (STEM) or transmission electron microscope (TEM) to measure the ratio of the elements present. The difference in crystal structure of the main phase and segregated phase can for example be judged by using electron beam diffraction using a transmission electron microscope (TEM).

The internal electrode layer 3 is preferably comprised of a conductive material of a base metal acting substantially as an electrode. As the base metal used as a conductive material, Ni or an Ni alloy is preferable.

As an external electrode 4, normally at least one of Ni, Pd, Ag, Au, Cu, Pt, Rh, Ru, Ir, etc. or an alloy of the same may be used. Normally, Cu, a Cu alloy, Ni, an Ni alloy, etc. or Ag, an Ag—Pd alloy, an In—Ga alloy, etc. may be used.

Method of Production of Multilayer Ceramic Capacitor

Next, one example of the method of production of the multilayer ceramic capacitor 1 according to the present embodiment will be explained.

(1) In the present embodiment, a dielectric layer paste for forming the interlayer dielectric layers for firing and the outside dielectric layers for firing for forming the interlayer dielectric layers 2 and outside dielectric layers 20 shown in FIG. 1 after firing and an internal electrode layer paste for forming the internal electrode layers before firing for forming the internal electrode layers 3 shown in FIG. 1 after firing are prepared. Further, an external electrode paste is also prepared.

The dielectric layer paste is prepared by kneading a ceramic material powder and organic vehicle.

Ceramic Material Powder

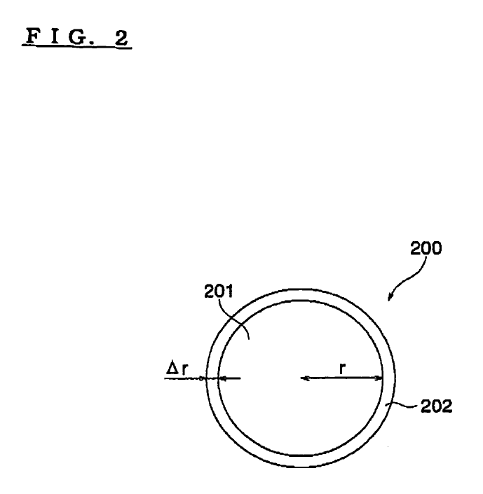

The ceramic material powder 200 used in the present embodiment, as shown in FIG. 2, is comprised of the main ingredient particles 201 having on their surfaces a covering layer 202 comprised of a secondary ingredient additive.

As the main ingredient particles 201, barium titanate is used. Barium titanate is an ingredient forming, after firing, the main ingredient of the dielectric ceramic composition forming the interlayer dielectric layers 2 and outside dielectric layers 20 shown in FIG. 1. The composition of the barium titanate is not particularly limited in the present invention, but is expressed by the formula (BaO)ₘ·TiO₂. One with a molar ratio “m” in the formula of m=0.990 to 1.020 is preferably used.

As the secondary ingredient additive, at least one of magnesium oxide and/or a compound forming magnesium oxide after firing, manganese oxide and/or a compound forming manganese oxide after firing, and chromium oxide and/or a compound forming chromium oxide after firing is used. In this case, when converting barium titanate to BaTiO₃, magnesium oxide to MgO, manganese oxide to MnO, and chromium oxide to Cr₂O₃, the ratio with respect to 100 moles of BaTiO₃ is preferably MgO:0 to 3 moles (however, excluding 0 mole) and MnO+Cr₂O₃:0 to 0.5 mole (however, excluding 0 mole).

Further, as the secondary ingredient additive, at least one of vanadium oxide and/or a compound forming vanadium oxide after firing, tungsten oxide and/or a compound forming tungsten oxide after firing, tantalum oxide and/or a compound forming tantalum oxide after firing, and niobium oxide and/or a compound forming niobium oxide after firing is preferably used.

In this case, when converting vanadium oxide to V₂O₅, tungsten oxide to WO₃, tantalum oxide to Ta₂O₅, and niobium oxide to Nb₂O₅, the ratio with respect to 100 moles of BaTiO₃ is preferably V₂O₅+WO₃+Ta₂O₅+Nb₂O₅:0 to 0.5 mole (however, except 0 mole) is preferable.

Alternatively, as the secondary ingredient additive, an R oxide (where R is at least one of Sc, Er, Tm, Yb, Lu, Y, Dy, Ho, Tb, Gd, and Eu) and/or a compound forming an R oxide after firing is preferably used. In this case, when converting the R oxide to R₂O₃, the ratio with respect to 100 moles of BaTiO₃ is preferably R₂O₃:0 to 5 moles (however, except 0 mole).

Alternatively, as a secondary ingredient additive, silicon oxide and/or a compound forming silicon oxide after firing is preferably used. In this case, when converting the silicon oxide to SiO₂, the ratio with respect to 100 moles of BaTiO₃ is preferably SiO₂: 0.5 to 12 moles.

Alternatively, as a secondary ingredient additive, barium oxide and/or a compound forming barium oxide after firing, strontium oxide and/or a compound forming strontium oxide after firing, and calcium oxide and/or a compound forming calcium oxide after firing are preferably used. In this case, when converting barium oxide to BaO, strontium oxide to SrO, and calcium oxide to CaO, the ratio with respect to 100 moles of BaTiO₃ is preferably BaO+SrO+CaO:0.5 to 12 moles.

The above secondary ingredient additive is the ingredient forming, after firing, the secondary ingredient of the dielectric ceramic composition forming the interlayer dielectric layers 2 and outside dielectric layers 20 shown in FIG. 1.

In the present invention, the average thickness of the covering layer 202 is controlled in accordance with the average radius of the main ingredient particles 201. Specifically, when the average radius of the main ingredient particles 201 is “r” and the average thickness of the covering layer 202 is “Δr”, the Δr is controlled to be included in the range of 0.015r to 0.055r. The method of controlling the average thickness Δr of the covering layer 202 to a predetermined range is not particularly limited, but in the present embodiment, as explained later, it is controlled by changing the treatment temperature and treatment time of the heat treatment step. The details will be explained later.

The ceramic material powder is given an average grain size of preferably 5 μm or less, more preferably 0.05 to 1.00 μm or so. The dielectric ceramic composition (sintered body) produced by using such a special ceramic material powder, as explained above, has a main phase mainly comprised of the main ingredient and a segregated phase differing in composition and crystal structure from the main phase and containing the secondary ingredient in an amount, converted to oxide, of at least 10 wt %. The area ratio of the segregated phase when observing the cross-section of the dielectric ceramic composition can be made 8% or less of the area of the observation field.

Method of Production of Ceramic Material Powder

The ceramic material powder 200 used in the present embodiment shown in FIG. 2 can be produced by the method shown next. However, the present invention is not limited to the following method.

(1-1) First, a powder-state main ingredient (main ingredient powder) and solution-state secondary ingredient (secondary ingredient solution) are prepared.

In the present embodiment, as the main ingredient powder, it is preferable to use barium titanate with an average particle size of the primary particles within a predetermined range. As the barium titanate, it is preferable to use powder with an average particle size of the primary particles of preferably 0.01 to 1.0 μm, more preferably 0.05 to 0.5 μm. If the average particle size of the primary particles is too small, the dielectric constant of the obtained capacitor is liable to sharply drop. Conversely, if the average particle size of the primary particles is too large, the obtained capacitor is liable to easily short-circuit or suffer from poor breakdown voltage.

The secondary ingredient solution used in the present embodiment is obtained by for example alkoxidating, completing, or chlorinating the secondary ingredient element to obtain a compound in the state of a metal alkoxide, metal complex, or metal salt, then adding this compound to a solvent.

As the secondary ingredient metal element, at least one of magnesium, manganese, and chromium is used. Alternatively, as the secondary ingredient metal element, at least one type of vanadium, tungsten, tantalum, and niobium is preferably used. Alternatively, as the secondary ingredient metal element, R (where R indicates at least one of Sc, Er, Tm, Yb, Lu, Y, Dy, Ho, Tb, Gd, and Eu) is preferably used. Alternatively, as the secondary ingredient metal element, silicon is preferably used. Alternatively, as the secondary ingredient metal element, barium, strontium, and calcium are preferably used.

The “alkoxide” means a compound with the hydrogen of the hydroxyl group of the alcohol substituted by a metal element “M”. As the alkoxide, methoxide (also referred to as a “methylate”, CH₃OM), ethoxide (also referred to as an “ethylate”, C₂H₅OM), propoxide, butoxide, pentyloxide, ethoxyethoxide, methoxyethoxide, etc. may be mentioned. Therefore, a metal alkoxide obtained by alkoxidation of a secondary ingredient metal element includes for example Ba(OC₂H₅)₂, Ca(OC₂H₅)₂, Sr(OC₂H₅)₂, Mg(OC₂H₅)₂, Si(OC₂H₅)₄, V (OC₂H₅)₅, etc.

The number of the alcoholate ligands of the metal alkoxide is normally 1 to 6. Further, in the same metal alkoxide, the alcoholate ligands positioned at the metal are normally the same, but may also be different depending on the case.

Note that the Cr, Y, Mn, W, Zr, etc. may be used as acetates, oxalates, or other complexes. Further, the secondary ingredient metal elements may also be used as β-diketonate complexes.

As the solvent, an alcohol, benzene or its derivative, or chloroform, or the like alone or also a mixed solvent of benzene or a benzene derivative and an alcohol etc. may be used.

The content (concentration) of each compound in the secondary ingredient solution is suitably adjusted in accordance with the content of the secondary ingredient additive in the finally obtained dielectric ceramic composition.

(1-2) Next, the secondary ingredient solution is mixed with the main ingredient powder. The ratio of mixture of the two is suitably adjusted by the content (concentration) of the compound of the metal element of the secondary ingredient in the secondary ingredient solution, the amount of the secondary ingredient solution, etc.

(1-3) Next, the mixed solution of the main ingredient powder and secondary ingredient solution is heat treated. The heat treatment is performed for causing a heat decomposition reaction so that the compound of the secondary ingredient metal element becomes an oxide. By performing the heat treatment, the solvent in the mixed solution is driven off and an oxide of the secondary ingredient metal element bonding with the main ingredient powder is precipitated so as to cover the surface of the main ingredient powder.

In the present embodiment, the treatment temperature and treatment time in the heat treatment step are changed. Due to this, the average thickness Δr of the covering layer 202 formed on the surface of the barium titanate used as the main ingredient particles is controlled. In the present embodiment, the heat treatment temperature and heat treatment time are determined so that the average thickness Δr of the covering layer becomes the range of 0.015r to 0.055r.

Specifically, the heat treatment temperature is preferably 500 to 1100° C., more preferably 600 to 1050° C. If the heat treatment temperature is too low, the heat decomposition reaction will be insufficient, while if too high, pulverization of the main ingredient particles tends to become difficult. Note that the upper limit of the heat treatment temperature was made 1100° C. or so because by adjusting the heat treatment temperature to a temperature of 100° C. or so lower than the temperature at which neck growth starts (for example, around 1200° C.), it is believed possible to efficiently form a covering layer.

The heat treatment time is preferably 1 to 12 hours, more preferably 1 to 8 hours. By raising the treatment temperature at the same treatment time or lengthening the treatment temperature time at the same treatment temperature, the average thickness of the covering layer tends to be formed thicker. Therefore, it is necessary to suitably adjust the heat treatment temperature and time according to the composition of the main ingredient particles or type of the secondary ingredient additive.

Other conditions of the heat treatment are as follows. The rate of temperature rise is preferably 50 to 500° C./hour, more preferably 100 to 300° C./hour. The treatment atmosphere is normally the air (atmosphere).

(1-4) Next, the heat treated powder is pulverized by alumina rolls etc. and if necessary mixed with a diffusion solvent such as pure water by a ball mill etc., then dehydrated and dried to obtain the ceramic material powder of the present embodiment.

The drying is preferably performed under the following conditions. The drying temperature is preferably 80 to 120° C. The drying time is preferably 5 to 20 hours.

The average thickness or state of coverage of the covering layer can be confirmed by analysis using a transmission electron microscope (TEM) or scanning transmission electron microscope (STEM). By using high resolution electron microscopy using a transmission electron microscope, electron energy loss spectroscopy (EELS), or energy-dispersive X-ray spectroscopy (EDS), the covering area can be confirmed and the covering thickness can be measured.

For observation by a TEM or STEM, for example, an observation sample prepared by the method described in Japanese Patent Publication (A) No. 2003-294594 may be used, Specifically, the above-mentioned ceramic material powder and resin are mixed to obtain a mixture, then the mixture is pressed to prepare an observation sample with regions of a thickness of 20 μm or less.

As the resin to be mixed with the ceramic material powder, a heat curing resin, photocuring resin, etc. may be used. Among these, a heat curing resin is preferably used. This is because a heat curing resin falls in viscosity by heating to 100° C. or so, so until it starts to cure, the powder and resin can be easily mixed and bubbles are not easily entrained, so the ratio of the ceramic material powder to the resin can be raised. As the heat curing resin, an epoxy resin, phenol resin, melamine resin, etc. may be mentioned, but an epoxy resin, which cures in a short time and is relatively resistant to electron beams, is particularly preferable. Further, the photocuring resin is generally comprised of a composition of a monomer, oligomer, photopolymerization initiator, and various additives (stabilizer, filler, pigment, etc.)

In the present embodiment, the ratio of the ceramic material powder to the resin (volume ratio) is preferably made 2 or more. By doing this, it is possible to greatly raise the density of the ceramic material powder in the sample and increase the number of particles of the powder per observation area even with observation under a TEM. Therefore, it becomes possible to sufficiently obtain information on the particles of the powder. The ratio of the ceramic material powder with respect to the resin (volume ratio) differs depending on the type of the resin, the size of the ceramic material powder, etc., but is preferably 2 to 8, more preferably 3 to 8, still more preferably 5 to B. To raise the powder density in the sample, the ratio of the powder to the resin (volume ratio) is preferably made as high as possible, so the ratio of the powder to the resin (volume ratio) is preferably made at least 2. On the other hand, if the ratio of the powder to the resin (volume ratio) is too large, the amount of the resin functioning as an embedding agent for immobilizing the powder becomes small, so preparation of a sample tends to become difficult.

When using the observation sample for observation by a TEM, after forming and pressing the above-mentioned mixture, a sample is cut out and ion milled.

When cutting out a sample, the sample obtained after pressing is cut to the size of a TEM sample. This cutting work can be performed using for example a knife. As the TEM sample, normally one of a diameter of 3 mmp is used. Therefore, it is also possible to directly cut out a 3 mmφ piece and use it as the TEM sample or for example bond a 2 mm×2 mm or so square shaped sample to the hole part of a 3 mmφ outside diameter single-hole mesh (so-called “TEM mesh”) by a resin etc. to prepare a TEM sample.

Ion milling may be performed using a known milling system. The time required for the ion milling differs depending on the size of the cut out sample, but normally is 1 to 2 hours or so. Note that the ion milling normally can be performed using Δr ions etc. By going through this ion milling step, the thickness of the sample becomes 100 Nm or less and use as a TEM observation sample becomes possible.

The organic vehicle contains a binder and a solvent. As the binder, for example, ethyl cellulose, polyvinyl butyral, acryl resin, or another ordinary binder may be used. The solvent also is not particularly limited, but terpineol, butyl carbitol, acetone, toluene, xylene, ethanol, or another organic solvent may be used.

The dielectric layer paste may be formed by kneading a ceramic material powder and a vehicle comprised of water in which a water-soluble binder is dissolved. The water-soluble binder is not particularly limited, but a polyvinyl alcohol, methyl cellulose, hydroxethyl cellulose, water-soluble acryl resin, emulsion, etc. may be used.

The internal electrode layer paste is prepared by kneading a conductive material comprised of the above-mentioned various conductive metals or alloys or various oxides, organic metal compounds, resinates, etc. forming the above-mentioned conductive materials after firing and the above-mentioned organic vehicle.

The external electrode paste is prepared in the same way as this internal electrode layer paste.

The content of the organic vehicle in each paste is not particularly limited, but normally the content should be made for example 1 to 5 wt % or so of binder and 10 to 50 wt % or so of solvent. Further, each paste may also contain, in accordance with need, an additive selected from various dispersants, plasticizers, dielectrics, insulators, etc.

(2) Next, the dielectric layer paste containing the ceramic material powder and the internal electrode layer paste are used to prepare a green chip comprised of the dielectric layers before firing and internal electrode layers before firing stacked together, the green chip is subjected to a binder removal step, firing step, and if necessary an annealing step to obtain a sintered body so as to obtain a capacitor body 10 formed with external electrodes 4 and produce a multilayer ceramic capacitor 1.

Among these, in the present embodiment, it is preferable to fire the green chip after removal of the binder under the following conditions. The rate of temperature rise is preferably 50 to 500° C./hour, more preferably 100 to 300° C./hour.

The firing holding temperature is preferably 1200 to 1350° C., more preferably 1200 to 1320° C., while the holding time of the holding temperature is preferably 0.5 to 8 hours, more preferably 1 to 3 hours. If the firing holding temperature is too low, even if making the holding time of the holding temperature longer, the densification becomes insufficient, while if too high, breakage of the electrodes due to abnormal sintering of the internal electrode layers, deterioration of the temperature characteristic of the capacity due to diffusion of the conductive material forming the internal electrode layers and reduction of the dielectric ceramic composition forming the dielectric layers become easier. In particular, in the present embodiment, firing at the firing holding temperature and holding time is advantageous in the point of enabling the above-mentioned object of the present invention to be achieved more easily.

The rate of temperature drop is preferably 50 to 500° C./hour, more preferably 200 to 300° C./hour.

In the present embodiment, the firing is performed in a reducing atmosphere. As the atmospheric gas in the reducing atmosphere, for example, a moistened mixed gas of N₂ and H₂ is preferably used.

The oxygen partial pressure in the firing atmosphere is preferably 6×10⁻⁸ to 10⁻⁴ Pa. If the oxygen partial pressure is too low, the conductive material of the internal electrode layers will become abnormally sintered and will sometimes end up breaking, while if too high, the internal electrode layers will tend to oxidize,

The multilayer ceramic capacitor 1 obtained in the present embodiment is produced using the ceramic material powder of the present invention, so the deterioration of the reliability or drop in the electrical capacity is small and a high capacity and high reliability are obtained.

Above, embodiments of the present invention were explained, but the present invention is not limited to these embodiments in any way and may of course, be worked in various ways within the scope of the present invention.

The ceramic material powder used in the present embodiment may be produced, other than by the above method of production, by the drying method of adding to the basic composition powder of the ceramic dielectric a carbonate or oxide of the metal elements to be added or mixtures of the same, mixing and pulverizing them, then calcining the result. With this method, uniform, micro diffusion of carbonates or oxides of the added metal elements to the ceramic basic composition powder by just the mixing step becomes impossible. However, at the subsequent calcining step, the secondary ingredient additive is diffused to the surface of the barium titanate particles. At less than the temperature at which necking of the barium titanate particles occurs, the higher the calcining temperature and the longer the calcining time, the thicker the covering layer containing the secondary ingredient additive that can be grown. Therefore, by suitably controlling the calcining temperature, calcining time, and amount of the secondary ingredient additive, it is possible to control the thickness of the covering layer.

### EXAMPLES

Below, the present invention will be further explained with reference to detailed examples, but the present invention is not limited to these examples.

Production of Ceramic Material Powder

First, BaTiO₃ of an average grain size of about 0.2 to 0.4 μm as main ingredient particles and as MgO, MnCO₃, V₂O₅, Y₂O₃, BaCO₃, CaCO₃, and SiO₂ as secondary ingredient additives were prepared.

Next, the secondary ingredient additives were added to the BaTiO₃ of the main ingredient particles to give amounts, with respect to a total 100 atom % converted to elements, of Mg:10 atom %, Mn:2 atom %, V:1 atom %, Y:35 atom %, Ba:16 atom %, Ca:11 atom %, and Si:25 atom % using a secondary ingredient solution of the following composition. The amount of the secondary ingredient additive added was 2.2 parts by weight with respect to 100 parts by weight of the main ingredient particles.

In this example, as the solvent for making the secondary ingredient additives a solution, methanol was used. Note that the following Ba is the barium ingredient added as a secondary ingredient.

The “mole/L” attached after each secondary ingredient additive indicates the concentration of each additive. The amount added is the amount added with respect to BaTiO₃/100 g of the main ingredient particles.
Ba(C₅H₇O₂)₂: barium bis (2,4-pentadionate), concentration: 0.65 mole/L, amount added: 850 ml.
Ca (C₅H₇O₂)₂: calcium bis(2,4-pentadionate), concentration: 0.70 mole/L, amount added: 320 ml,
Si(OC₂H₅)₄: tetraethoxysilane, concentration: 0.75 mole/L, amount added: 440 ml,
Y₂(C₂O₄)₃·9H₂O: yttrium oxalate, concentration: 0.50 mole/L, amount added: 1250 ml,
Mg(C₂O₄) 2H₂O: magnesium oxalate, concentration: 0.71 mole/L, amount added: 1580 ml,
Cr(C₂O₄)·6H₂O; chromium oxalate, concentration: 0.20 mole/L, amount added: 565 ml,
VO(C₅H₇O₂)₂: vanadium oxide bis(2,4-pentadionate), concentration: 0.10 mole/L, amount added: 323 ml,

Next, the obtained secondary ingredient solution was added to the main ingredient particles in the following sequence, mixed, and heat treated repeatedly.

First, Ba(C₅H₇O₂)₂ and Ca(C₅H₇O₂)₂ were added to and mixed with 100 g of the main ingredient particles in the above concentrations and amounts added. Next, the solvent in the solution was driven off and the result was heat treated at the treatment temperature and treatment time shown in Table 1. Due to this, the secondary ingredient additives Ba and Ca were precipitated to cover the main ingredient as oxides bonded with the main ingredient particles.

Second, the Si (OC₂H₅) 4 was added to and mixed with the BaTiO₃ Of the main ingredient particles with Ba and Ca oxides bonded on the surface in the above concentrations and amounts added. Next, the solvent in the solution was driven off and the result was heat treated at the treatment temperature and treatment time shown in Table 1. Due to this, the surfaces of the main ingredient particles were formed with Si so as to cover the main ingredient as an oxide bonded with the main ingredient particles and the secondary ingredient additives.

Third, Y₂(C₂O₄)₃·9H₂O, Mg(C₂O₄)·2H₂O, and Cr(C₂O₄)·6H₂O were simultaneously added to and mixed with the main ingredient particles BaTiO₃ with the bonded Ba, Ca, and Si in the above concentrations and amounts added. Next, the solvent in the solution was driven off and the result was heat treated at the treatment temperature and treatment time shown in Table 1. Due to this, the surfaces of the main ingredient particles were formed with the Y, Mg, and Cr so as to cover the main ingredient as oxides bonded with the main ingredient particles and the secondary ingredient additives.

Fourth, VO(C₅H₇O₂)₂ was simultaneously added to and mixed with the main ingredient particles BaTiO₃ with the bonded Ba, Ca, Si, Y, Mg, and Cr in the above concentration and amount added. Next, the solvent in the solution was driven off and the result was heat treated at the treatment temperature and treatment time shown in Table 1. Due to this, the surfaces of the main ingredient particles were formed with V so as to cover the main ingredient as an oxide bonded to the main ingredient particles and the secondary ingredient additives.

Further, a ball mill was used to wet mix and pulverize this using pure water as a diffusion solvent, then the result was dehydrated and dried at 100° C. for 12 hours to obtain a ceramic material powder.

Average Radius of Main Ingredient Particles and Average Thickness and Covering State of Covering Layer

An observation sample was prepared to confirm the average radius of the main ingredient particles in the obtained ceramic material powder, the average thickness of the covering layer, and the covering state. First, the obtained ceramic material powder was kneaded with the epoxy resin to obtain a ratio of ceramic material powder with respect to the resin (volume ratio) of 7 or so so as to obtain a mixture. Next, the obtained mixture was subjected to a temperature of 150° C. and a suitable pressure to stretch it thin, then solidified to obtain a thickness of 10 μm. A sample was cut out, then ion milled to prepare an observation sample having portions of thickness of 100 Nm or less.

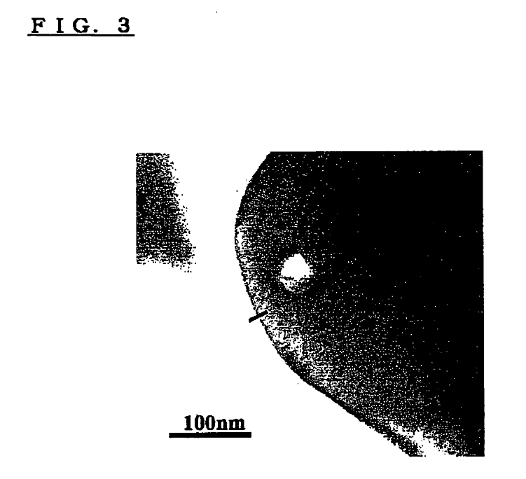

The prepared observation sample was used to confirm the covering region made of the second ingredient additive of the ceramic material powder. A bright field image obtained by a scanning transmission electron microscope (STEM) is shown in FIG. 3. As shown in FIG. 3, it was confirmed that the surface of the BaTiO₃ of the main ingredient particles had a covering layer of a predetermined thickness.

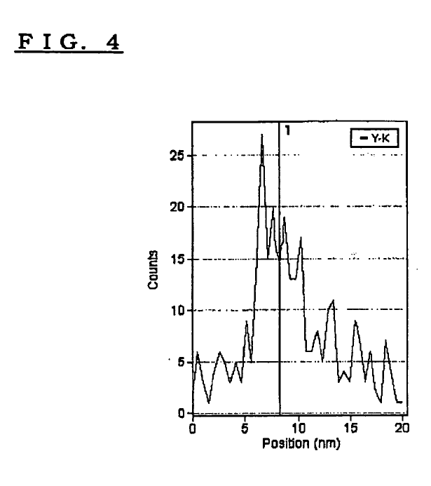

The average thickness of the covering layer present on the surface of the BaTiO₃ of the main ingredient particles was found using an EDS (energy-dispersive X-ray spectroscopy) system attached to the STEM. Specifically, an electron beam was run from the outside to the inside of the BaTiO₃ particles in a line. A graph plotting the count of the characteristic X-rays (K-lines) of Y detected at this time is shown in FIG. 4. Further, from the graph shown in FIG. 4, the half width of the line profile of FIG. 4 near the surface of the BaTiO₃ of the main ingredient particles (=width of peak at height of ½ of peak height) was found. This value was judged as the average thickness of the covering layer comprised of the secondary ingredient additives. This measurement was performed at several dozen locations and the average value thereof was used as the average thickness of the covering layer. The results are shown in Table 1. In the example shown in FIG. 4, the half value is near the 13 count and the width is 5 Nm. Further, a photograph of the element mapping image of the ceramic material powder of the Sample 2 using the characteristic X-rays (K-lines) of Y is shown in FIG. 5. As shown in FIG. 5, it can be confirmed that the surface of the BaTiO₃ Of the main ingredient particles has a Y of the covering layer present in a predetermined thickness.

The average radius “r” of the main ingredient particles was found be observation by a transmission electron microscope (TEM). The sample was dispersed in ethanol which was then dropped on a microgrid comprised of a copper frame over which a collodion film was stretched and then was dried. The results are shown in Table 1.

Preparation of Dielectric Layer Paste

To 100 parts by weight of the obtained ceramic material powder, 10 parts by weight of PVB (polyvinyl butyral) resin as a binder, 5 parts by weight of DOP (dioctyl phthalate) as a plasticizer, and 150 parts by weight of ethanol as a solvent were kneaded by a ball mill after weighing so as to form a slurry to obtain a dielectric layer paste.

Preparation of Internal Electrode Layer Paste

To 100 parts by weight of Ni particles of an average particle size 0.3 μm, 40 parts by weight of an organic vehicle (8 parts by weight of ethyl cellulose resin dissolved in 92 parts by weight of butyl carbitol) and 10 parts by weight of butyl carbitol were kneaded by a triple roll to form a slurry and obtain an internal electrode layer paste.

Preparation of External Electrode Layer Paste

To 100 parts by weight of Cu particles of an average particle size of 0.5 μm, 35 parts by weight of an organic vehicle (8 parts by weight of ethyl cellulose resin dissolved in 92 parts by weight of butyl carbitol) and 7 parts by weight of butyl carbitol were kneaded to form a slurry and obtain an external electrode layer paste.

Preparation of Multilayer Ceramic Chip Capacitor Sample

The obtained dielectric layer paste and internal electrode layer paste were used to produce the multilayer ceramic chip capacitor 1 shown in FIG. 1 in the following way.

First, the PET film was coated with a dielectric layer paste by the doctor blade method to a predetermined thickness and then dried to form a 10 μm thickness ceramic green sheet. In the present embodiment, a plurality of these ceramic green sheets were prepared as first green sheets (interlayer dielectric layers before firing).

The obtained first green sheet was formed with a predetermined pattern by screen printing an internal electrode layer paste so as to obtain a ceramic green sheet having an electrode pattern (thickness; 2.0 μm). In the present embodiment, a plurality of these ceramic green sheets were prepared as second green sheets (internal electrode layers before firing+interlayer dielectric layers before firing).

The first green sheets were stacked to a thickness of 800 μm to form a group of green sheets (outside dielectric layers before firing). Five of the second green sheets were stacked on the group of green sheets, then a similar group of green sheets was stacked on this and the result heated and pressed under conditions of a temperature of 80° C. and a pressure of 1 ton/cm² to obtain a green stack (pre-fired body).

Next, the obtained stack was cut to a predetermined size, then treated to remove the binder, fired, and annealed under the following conditions to obtain a sintered body.

The binder was removed under conditions of a rate of temperature rise of 30° C./hour, a holding temperature of 250° C., a holding time of 8 hours, a rate of temperature drop of 200° C./hour, and a treatment atmosphere of an air atmosphere.

The firing was performed under conditions of a rate of temperature rise of 200° C./hour, a holding temperature of 1300° C., a holding time of 2 hours, a rate of temperature drop of 200° C./hour, and a treatment atmosphere of a reducing atmosphere (prepared by passing a mixed gas of N₂ and H₂ through steam at an oxygen partial pressure of 10⁻⁶ Pa).

The annealing was performed under conditions of a rate of temperature drop of 200° C./hour, a holding temperature of 1050° C., a holding time of 2 hours, a rate of temperature rise of 200° C./hour, and a treatment atmosphere of a neutral atmosphere (prepared by passing N₂ gas through steam at an oxygen partial pressure of 0.1 Pa).

Area Ratio of Segregated Phase

First, Sample 5 corresponding to Comparative Example 1, Sample 7-1 corresponding to Example 1, and Sample 6 corresponding to Example 2 were obtained by cutting the obtained sintered bodies (dielectric ceramic compositions) at the planes parallel to the stacking direction of the dielectric layers and internal electrode layers and mechanically polishing the cut cross-sections. Further, the back surfaces were mechanically polished to prepare regions of a thickness of 20 μm or less. After this, the surfaces were ion milled to reduce parts to thicknesses of 100 nm or less for use as STEM observation samples. Next, the thinned parts were measured using an EDS attached to an STEM, element mapping was performed for the Y element, Ti element, and Ba element, and the area ratio of the segregated phase was measured from the results. The ratios of the elements were calculated using a STEM by irradiating an electron beam of an irradiation probe diameter of 5 nmφ or less at the measurement location, analyzing the energy of the X-rays produced from the sample using EDS, then calculating it from the intensity profile of the X-rays measured. The element mapping was measured using an observation field of 1 μm×1 μm (with one side about five times the average particle size of the main phase). As a result, the area ratio of the segregated phase was 9% in Sample 5 corresponding to Comparative Example 1, 6% in Sample 7-1 corresponding to Example 1, and 2% in Sample 6 corresponding to Example 2.

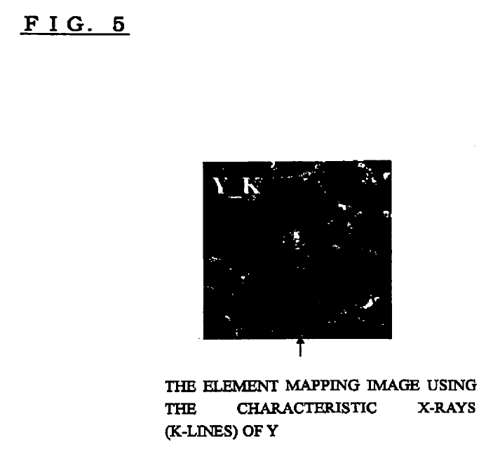

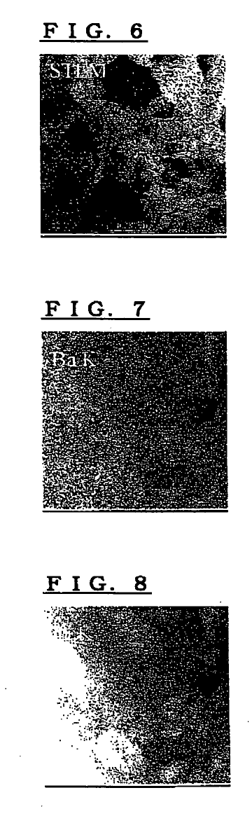

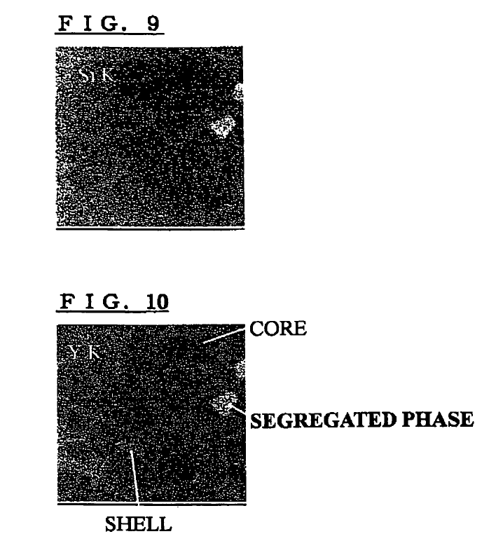

By way of reference, a photograph showing the bright field image of the sintered article of Sample 6 using a STEM is shown in FIG. 6. Further, the same Sample 6 was measured by element mapping. The obtained photographs are shown in FIGS. 7 to 10. In FIG. 7, the brighter the color of the location, the greater the amount of the Ba element signified. In FIG. 8, the brighter the color of the location, the greater the amount of the Ti element signified. In FIG. 9, the brighter the color of the location, the greater the amount of the Si element signified. In FIG. 10, the brighter the color of the location, the greater the amount of the Y element signified.

Here, looking at FIG. 10, the core and shell forming the main phase and the segregated phase could be confirmed. The percentages of the elements present in each region, converted to oxides, were as follows: In the core BaO was present in an amount of 69 wt %, TiO₂ in an amount of 31 wt %, SiO₂ in an amount of 0 wt %, and Y₂O₃ in an amount of 0 wt %. In the shell, BaO was present in an amount of 67 wt %, TiO₂ in an amount of 30 wt %, SiO₂ in an amount of 0 wt %, and Y₂O₃ in an amount of 3 wt %. In the segregated phase, BaO was present in an amount of 27 wt %, TiO_{z} in an amount of 4 wt %, SiO₂ in an amount of 17 wt %, and Y₂O₃ in an amount of 52 wt %.

That is, the segregated phase differs greatly in composition and crystal structure from the main phase comprised mainly of the main ingredient (BaTiO₃, core and shell corresponding to same) and can be understood as a region including the secondary ingredient (SiO₂ or Y₂O₃) in an amount, converted to an oxide, of 10 wt % or more (17 wt %, 52 wt %). Note that the difference in crystal structure of the main phase and segregated phase was judged by electron beam diffraction using a transmission electron microscope (TEM).

On the other hand, the shell can be understood to contain only the Y element in an amount, converted to Y₂O₃, of less than 10 wt % (specifically 3 wt %). Note that even the fine regions formed at the triple points of the main phase particles and in which a ratio of additive elements was 10% or more were also counted as the segregated phase.

Next, the end faces of the obtained sintered article were polished by sand blasting, then external electrode paste was transferred to the end faces and fired in a moistened N₂+H₂ atmosphere at 800° C. for 10 minutes to form external electrodes and obtain a multilayer ceramic capacitor sample of the configuration shown in FIG. 1.

The size of each obtained sample was a length of 3.2 mm×width of 1.6 mm×height of 1.2 mm, the number of interlayer dielectric layers sandwiched between the internal electrode layers was 4, the thickness was 6.5 μm and the thickness of the internal electrode layers was 1.5 μm.

Evaluation of Characteristics of Capacitor Sample

Each obtained capacitor sample was evaluated for relative dielectric constant (ε), the temperature characteristic (TC) of the electrostatic capacity, and the insulation resistance (IR) life under a DC field.

The relative dielectric constant ε was calculated for the capacitor sample from the electrostatic capacity (no unit) measured at a reference temperature of 25° C. by a digital LCR meter (YHP, 4274A) under conditions of a frequency of 1 kHz and input signal level (measurement voltage) of 1.0 Vrms. The criteria for evaluation was 1800 or more as a good value.

For the temperature characteristic (TC) of the electrostatic capacity, the X7R characteristic of the EIAJ standard and the B characteristic of the Japan Industrial Standard (JIS) were evaluated. First, for the X7R characteristic, a capacitor sample was measured for electrostatic capacity by a digital LCR meter (YHP, 4274A) under the conditions of a frequency 1 kHz and input signal level (measurement voltage) of 1 Vrms and it was investigated if the rate of change of electrostatic capacity (ΔC/C) with respect to temperature at a reference temperature of 25° C. satisfied the X7R characteristic of the EIAJ standard in the temperature range of −55 to 125° C. (within ±15%). When satisfying it, the O mark was used, while when not satisfying it, the X mark was used. Next, for the B characteristic, a capacitor sample was measured for electrostatic capacity under similar conditions and it was investigated if the rate of change of the electrostatic capacity (ΔC/C) with respect to temperature at a reference temperature of 20° C. satisfied the B characteristic of the Japan Industrial Standard (JIS) (within ±10%). When satisfying it, the O mark was used, while when not satisfying it, the X mark was used.

For the insulation resistance (IR) life under a DC field, the capacitor sample was subjected to an acceleration test at 220° C. under a 10V/μm field to measure the time (unit: hours) until the insulation resistance (IR) became 2×10⁵ Ω. The INSULATION RESISTANCE (IR) life was a good 5 hours or more, preferably 10 hours or more.

The results are shown in Table 1.

TABLE 1

| | | | | Main | | | | | | |
|---|---|---|---|---|---|---|---|---|---|---|
| | | Heat | | ingred. | | | | | | |
| | | treatment | | part. | Covering layer | | Relative | | | IR |
| | | Treat. | Treat. | Average | Average | Ratio of | dielec-tric | Temp. char. | | accel. |
| Sample | | temp. | time | radius r | thick. | Δr and r | constant | | B | life |
| no. | | (° C.) | (h) | (nm) | Δr (nm) | (Δr/r) | ε | X7R | char. | (h) |
| 1 | Comp. ex. | 700 | 1 | 100 | 1 | 0.01 | 4300 | X | X | 0.4 |
| 1-1 | Inv. ex. | 800 | 1 | 100 | 1.5 | 0.015 | 2700 | ◯ | ◯ | 12.0 |
| 2 | Inv. ex. | 800 | 5 | 100 | 3 | 0.03 | 2600 | ◯ | ◯ | 33.0 |
| 3 | Inv. ex. | 900 | 5 | 100 | 5 | 0.05 | 2500 | ◯ | ◯ | 28.0 |
| 3-1 | Inv. ex. | 900 | 7 | 100 | 5.5 | 0.055 | 1800 | ◯ | ◯ | 15.6 |
| 4 | Comp. ex. | 1000 | 7 | 100 | 10 | 0.1 | 1600 | X | X | 2.2 |
| 5 | Comp. ex. | 600 | 2 | 200 | 1 | 0.005 | 4800 | X | X | 0.3 |
| 5-1 | Inv. ex. | 800 | 3 | 200 | 3 | 0.015 | 3600 | ◯ | ◯ | 10.5 |
| 6 | Inv. ex. | 900 | 3 | 200 | 5 | 0.025 | 3500 | ◯ | ◯ | 14.0 |
| 7 | Inv. ex. | 900 | 7 | 200 | 9 | 0.045 | 3100 | ◯ | ◯ | 11.0 |
| 7-1 | Inv. ex. | 1000 | 5 | 200 | 11 | 0.055 | 2500 | ◯ | ◯ | 10.0 |
| 8 | Comp. ex. | 1000 | 10 | 200 | 15 | 0.075 | 1900 | X | X | 1.3 |

As shown in Table 1, in Samples 1 and 5, where the average thickness Δr of the covering layer was lower than the lower limit of the present invention, it could be confirmed that while the relative dielectric constant was sufficient, the INSULATION RESISTANCE (IR) accelerated life became extremely short and further the temperature characteristic also deteriorated. In Samples 4 and 8 where the average thickness Δr of the covering layer was above the upper limit of the present invention, the INSULATION RESISTANCE (IR) accelerated life did not become as short as with Samples 1 and 5, but was still not sufficient. In Sample 4, the relative dielectric constant and temperature characteristic deteriorated. Sample 8 had a sufficient relative dielectric constant, but deteriorated in temperature characteristic.

As opposed to this, in the samples where the average thickness Δr of the covering layer was in the range of the present invention, it could be confirmed that the balance of the relative dielectric constant, temperature characteristic, and INSULATION RESISTANCE (IR) accelerated life was superior.

While the invention has been described with reference to specific embodiments chosen for purpose of illustration, it should be apparent that numerous modifications could be made thereto by those skilled in the art without departing from the basic concept and scope of the invention.

1. A ceramic material powder comprised of main ingredient particles made of barium titanate having on their surface a covering layer made of a secondary ingredient additive, wherein
when an average radius of said main ingredient particles is “r” and an average thickness of said covering layer is “Δr”, said Δr is controlled to a range of 0.015r to 0.055r.

2. A ceramic material powder comprised of main ingredient particles made of barium titanate having on their surface a covering layer made of a secondary ingredient additive, wherein
when an average radius of said main ingredient particles is “r” and an average thickness of said covering layer is “Δr”, said Δr is controlled to a range of r (α−β) to r (α−β) (where the values of α and β are constants determined by the composition of the main ingredient particles, the type of the secondary ingredient additive forming the covering layer, etc.)

3. The ceramic material powder as set forth in claim 1, wherein said main ingredient particles are comprised of an oxide having a perovskite crystal structure.

4. A dielectric ceramic composition produced using a ceramic material powder as set forth in claim 1, having
a main phase mainly comprised of a main ingredient and
a segregated phase differing from said main phase in composition and crystal structure and including a secondary ingredient in an amount, converted to an oxide, of 10 wt % or more,
an area ratio of said segregated phase at the time of observation of the cross-section of said dielectric ceramic composition being 8% or less of the area of the observation field.

5. An electronic device having a dielectric layer, wherein said dielectric layer is comprised of a dielectric ceramic composition as set forth in claim 4.

6. A multilayer ceramic capacitor having a body comprised of a plurality of internal electrode layers and dielectric layers alternately stacked, wherein said dielectric layers are comprised of a dielectric ceramic composition as set forth in claim 4.

7. A method of producing a ceramic material powder comprised of main ingredient particles made of barium titanate having on their surface a covering layer made of a secondary ingredient additive, comprising:
a step of preparing a mixed solution of powder-state main ingredient particles and a solution-state secondary ingredient additive and
a step of heat treating said mixed solution,
a treatment temperature and treatment time of said heat treatment being changed to control an average thickness “Δr” of said covering layer to a range of 0.015r to 0.055r with respect to an average radius “r” of said main ingredient particles.

8. A method of producing a ceramic material powder comprised of main ingredient particles made of barium titanate having on their surface a covering layer made of a secondary ingredient additive, comprising:
a step of preparing a mixed solution of powder-state main ingredient particles and a solution-state secondary ingredient additive and
a step of heat treating said mixed solution,
a treatment temperature and treatment time of said heat treatment being changed to control an average thickness “Δr” of said covering layer to a range of r (α−β) to r (α−β) with respect to an average radius “r” of said main ingredient particles (where the values of α and β are constants determined by the composition of the main ingredient particles, the type of the secondary ingredient additive forming the covering layer, etc.).

9. A dielectric ceramic composition produced using a ceramic material powder as set forth in claim 2, having
a main phase mainly comprised of a main ingredient and
a segregated phase differing from said main phase in composition and crystal structure and including a secondary ingredient in an amount, converted to an oxide, of 10 wt % or more,
an area ratio of said segregated phase at the time of observation of the cross-section of said dielectric ceramic composition being 8% or less of the area of the observation field.

10. A dielectric ceramic composition produced using a ceramic material powder as set forth in claim 3, having
a main phase mainly comprised of a main ingredient and
a segregated phase differing from said main phase in composition and crystal structure and including a secondary ingredient in an amount, converted to an oxide, of 10 wt % or more,
an area ratio of said segregated phase at the time of observation of the cross-section of said dielectric ceramic composition being 8% or less of the area of the observation field.
